(19) United States
(12) Patent Application Publication
(10) Pub. No.: US 2020/0308418 A1
(43) Pub. Date: Oct. 1, 2020

(54) SURFACE REFLECTION PREVENTING COATING MATERIAL AND SURFACE REFLECTION PREVENTING COATING FILM

(71) Applicant: CANON KASEI KABUSHIKI KAISHA, Ibaraki (JP)

(72) Inventors: Hiroshi Abe, Tsukuba-shi (JP); Shota Inoguchi, Tsukuba-shi (JP)

(21) Appl. No.: 16/899,826

(22) Filed: Jun. 12, 2020

Related U.S. Application Data
(63) Continuation of application No. PCT/JP2018/045823, filed on Dec. 13, 2018.

(30) Foreign Application Priority Data
Dec. 18, 2017 (JP) 2017-242061

(51) Int. Cl. C09D 5/00; C09D 7/61; C09D 7/40; C09D 7/42; C09D 133/08

(52) U.S. Cl. CPC C09D 5/006; C09D 7/61; C08L 77/00; C09D 7/42; C09D 133/08; C09D 7/69

(57) ABSTRACT

There is provided a surface reflection preventing coating material having high reflection preventing performance and excellent pitch blackness even in a thin film. A surface reflection preventing coating material contains a binder resin, carbon black, hydrophobized dry silica, a roughening particle, and a solvent, wherein the roughening particle is a polyamide-based resin particle having an average particle diameter of 10 μm or more and 20 μm or less, an addition amount of the polyamide-based resin particle is 24 parts by mass or more and 44 parts by mass or less with respect to 100 parts by mass of the binder resin, and an addition amount of the dry silica is 14 parts by mass or more with respect to 100 parts by mass of the binder resin.

### CROSS-REFERENCE TO RELATED APPLICATIONS

This application is a Continuation of International Patent Application No. PCT/JP2018/045823, filed Dec. 13, 2018, which claims the benefit of Japanese Patent Application No. 2017-242061, filed Dec. 18, 2017, both of which are hereby incorporated by reference herein in their entirety.

### BACKGROUND OF THE INVENTION

### Field of the Invention

The present invention relates to a surface reflection preventing coating material and a surface reflection preventing coating film formed by using the surface reflection preventing coating material.

### Description of the Related Art

In an optical instrument such as a digital camera or a digital video camera, a ghost or a flare may occur in a formed image due to stray light caused by irregular reflection or scattering in an optical path part such as a lens barrel, which may be one of factors of image quality deterioration. Therefore, in order to suppress deterioration of optical performance due to such stray light, an optical path part such as a lens barrel part or a diaphragm is coated with a black reflection preventing coating material or a reflection preventing film is attached to the optical path part.

Meanwhile, the black reflection preventing coating material or the reflection preventing film has come to be used in a display apparatus in which a meter or the like emits light in order to improve visibility by preventing reflection at a peripheral portion, as well as used in the optical instrument such as a camera.

In addition, the black reflection preventing coating material has also attracted as a coating material for improving design in terms of pitch blackness thereof.

An example of the reflection preventing coating material for an optical instrument includes a light shielding film obtained by using a coating liquid containing a binder resin, a black fine particle, and a matting agent having a variation coefficient of 20% or more and an average particle diameter corresponding to 35% to 110% of a film thickness of the light shielding film (Japanese Patent No. 6096658).

A method of Japanese Patent No. 6096658 is implemented by absorbing light incident at all angles in the presence of the matting agent having different particle diameters from a large particle diameter to a small particle diameter through the use of the matting agent having the variation coefficient of 20% or more. However, the matting agent itself may be exposed to a surface of the film depending on a matting agent or binder resin to be selected. In particular, in a case where a matting agent having a large particle diameter is exposed to the surface of the film, reflection preventing performance may deteriorate.

In Japanese Patent Application Laid-Open No. 2017-57388, an example of a light shielding coating material for an optical component that contains a light shielding particle is disclosed, the light shielding particle including a base material particle and a plurality of second particles having an average particle diameter smaller than that of the base material particle, and the plurality of second particles being disposed on a surface of the base material particle.

In a case of a method of Japanese Patent Application Laid-Open No. 2017-57388, a minimum value of a regular reflectance of a coating film at an incident angle of 5 degrees is only 0.3%, which cannot cope with sufficient performance enhancement of the optical instrument.

In addition, as an example for a light shielding film, a method of reducing gloss by an uneven shape having macro and micro sizes different from each other is suggested in Japanese Patent Application Laid-Open No. 2010-175653.

The film formed by transferring the uneven shape is produced by the method of Japanese Patent Application Laid-Open No. 2010-175653. Unlike a coating material, the film cannot cope with an object having various shapes. In addition, it is difficult to control an uneven shape of a micro portion without using particles.

### SUMMARY OF THE INVENTION

An object of the present invention is to provide a surface reflection preventing coating material and a surface reflection preventing coating film having high reflection preventing performance and excellent pitch blackness.

A surface reflection preventing coating material according to the present invention contains a binder resin, carbon black, hydrophobized dry silica, a roughening particle, and a solvent, wherein the roughening particle is a polyamide-based resin particle having an average particle diameter of 10 μm or more and 20 μm or less, an addition amount of the polyamide-based resin particle is 24 parts by mass or more and 44 parts by mass or less with respect to 100 parts by mass of the binder resin, and an addition amount of the hydrophobized dry silica is 14 parts by mass or more with respect to 100 parts by mass of the binder resin.

Further features of the present invention will become apparent from the following description of exemplary embodiments.

### DESCRIPTION OF THE EMBODIMENTS

Embodiments of the present invention will be described below. Hereinafter, a surface reflection preventing coating material may be simply referred to as a “coating material”, and a surface reflection preventing coating film may be simply referred to as a “coating film”.

The surface reflection preventing coating material according to the present invention contains a binder resin, carbon black, hydrophobized dry silica, a roughening particle, and a solvent.

In the present embodiment, the binder resin is not particularly limited. A resin such as an acrylic resin, a urethane-based resin, an epoxy-based resin, an alkyd-based resin, or a polyester-based resin can be used. These binder resins can be used alone or as a mixture of two or more thereof. Among them, the acrylic resin which does not require crosslinking and can be a coating film only by drying the solvent after being coated to a substrate can be preferably used.

In addition, carbon black is used as a black coloring agent, but the type thereof is not particularly limited. Carbon black having characteristics corresponding to a desired black color or pitch blackness can be selected. In terms of the black color and the pitch blackness, carbon black for coloring having a nitrogen adsorption specific surface area of 100 m²/g or more and a volatile content of 3.0% or more is preferable.

An addition amount of the carbon black is not particularly limited, but is preferably 5 parts by mass or more and 30 parts by mass or less with respect to 100 parts by mass of the binder resin. This is because when the addition amount of the carbon black is 5 parts by mass or more, a variation in addition amount is small and a stable black color can thus be controlled, and when the addition amount of the carbon black is 30 parts by mass or less, a viscosity of the coating material is not increased too much and good coating properties can be maintained.

The hydrophobized dry silica is used as a matting agent. The dry silica can have a small unevenness formed on a large unevenness by the roughening particle and is excellent in reflection preventing performance as compared with untreated silica that is not subjected to a hydrophobic treatment or wet silica. In addition, due to its preparation method, the dry silica has a specific surface area larger than that of the wet silica having a small unevenness formed on a surface of a secondary aggregate. Accordingly, a specific surface area of a surface of the film is increased and scattering of incident light is increased. Therefore, it is considered that surface reflection preventing performance and a degree of blackness are excellent.

An addition amount of the hydrophobized dry silica is 14 parts by mass or more with respect to 100 parts by mass of the binder resin. When the addition amount of the hydrophobized dry silica is 14 parts by mass or more, in the coating film, a large amount of the hydrophobized dry silica is not embedded in the binder resin, and matting performance is exhibited. As the amount of silica is increased, the matting performance, the reflection preventing performance, and the pitch blackness tend to be improved. In addition, the addition amount of the hydrophobized dry silica is preferably 14 parts by mass or more and 19 parts by mass or less with respect to 100 parts by mass of the binder resin. When the addition amount of the hydrophobized dry silica is 19 parts by mass or less, the viscosity of the coating material is not increased too much, and the hydrophobized dry silica is sufficiently dispersed during preparation of the coating material. In addition, when the hydrophobized dry silica is dispersed, the viscosity of the coating material is sufficiently low, and coating properties are good. Therefore, the coating film is less likely to be uneven.

The roughening particle is a polyamide-based resin particle having an average particle diameter of 10 μm or more and 20 μm or less. Examples of the type of polyamide include, but are not particularly limited to, 6 nylon, 66 nylon, and 12 nylon. In general, a surface of the roughening particle formed of a resin is smooth. However, the polyamide-based resin particle is used, such that the binder resin and the hydrophobized dry silica as a matting agent are evenly present on the polyamide-based resin particle. Therefore, it is possible to form a coating film having a uniform and fine uneven shape. In a case where a roughening particle formed of another material, such as an acrylic resin particle or a polyurethane resin particle is used, a surface of the roughening particle may be precipitated on the coating film and a smooth surface of the roughening particle may be exposed. Therefore, there is a problem in that a surface reflectance is increased. The polyamide-based resin particle is preferably used in order to avoid the above problem is not caused.

The average particle diameter of the roughening particle is 10 μm or more and 20 μm or less. When the average particle diameter of the roughening particle is 10 μm or more, unevenness formation effect of the roughening particle may be enhanced and the reflection preventing performance may be sufficiently obtained. In a case where the average particle diameter of the roughening particle is 20 μm or less, when the roughening particle is used, a thickness of the coating film does not become too large. Therefore, a surface shape of the substrate can be maintained or the roughening particle does not fall off from the coating film.

Here, the average particle diameter described above refers to a value obtained by measuring a particle size distribution and obtaining a number average particle diameter by a laser diffraction scattering method.

An addition amount of the polyamide-based resin particle is 24 parts by mass or more and 44 parts by mass or less with respect to 100 parts by mass of the binder resin. In addition, the addition amount of the polyamide-based resin particle is more preferably 29 parts by mass or more and 39 parts by mass or less. When the addition amount of the polyamide-based resin particle is 24 parts by mass or more, the reflection preventing performance is excellent due to an increase in frequency of unevenness by the roughening particle formed on the surface of the coating film. When the addition amount of the roughening particle is 44 parts by mass or less, the roughening particle does not become too dense, and thus, the roughening particle does not fall off from the coating film.

As the solvent, an organic solvent is preferable. A coating material obtained by diluting the binder resin, the hydrophobized dry silica, the roughening particle, and the like with the organic solvent can be used. Any organic solvent can be used without particular limitation as long as it can dissolve the binder resin and can disperse the hydrophobized dry silica, the roughening particle, and the like. Examples of the organic solvent can include toluene, ethyl acetate, butyl acetate, and n-butanol. A dilution rate can be arbitrarily adjusted depending on use thereof. The dilution rate can be adequately adjusted by a coating method such as a spray method, a dip method, or a brush coating method. In addition, a plurality of solvents may be mixed and used to control a drying rate under a coating condition. The drying rate can be controlled by mixing the plurality of solvents.

The surface reflection preventing coating material according to the present invention preferably further contains a dye.

The type of the dye is not limited as long as the pitch blackness and the reflection preventing performance of the coating film can be maintained. A dye having a wavelength absorption property corresponding to a desired absorption wavelength can be arbitrarily selected and used. As the dye, a black dye is preferable.

In order to adjust the absorption wavelength, one type of dye may be used, or a plurality of types of dyes such as a red dye, a yellow dye, and a blue dye may be used in combination.

Examples of the types of the dye can include an azo dye, a metal complex dye, a naphthol dye, an anthraquinone dye, an indigo dye, a carbonium dye, a quinone imine dye, a xanthene dye, a cyanine dye, a quinoline dye, a nitro dye, a nitroso dye, a benzoquinone dye, a naphthoquinone dye, a phthalocyanine dye, and a metal phthalocyanine dye.

Examples of the dye added to absorb light with a wavelength in a visible light region can include a disazo-based dye such as Solvent Black 3 (for example, OIL BLACK HBB (manufactured by Orient Chemical Industries Co., Ltd.)) and a nigrosine-based dye such as Solvent Black 7 (for example, NUBIAN BLACK TN-870 (manufactured by Orient Chemical Industries Co., Ltd.)). In particular, as a dye absorbing light having a wavelength in a visible light region, the Solvent Black 3 having a wide absorption wavelength in a visible light region is preferably used.

In addition, examples of a dye added to absorb light with a wavelength in a near-infrared region can include a naphthalocyanine-based dye and a pigment such as a squarylium pigment, a diimmonium pigment, a diothylene pigment, or a cyanine pigment.

An addition amount of the dye is not particularly limited, but is preferably 3 parts by mass or more and 15 parts by mass or less with respect to 100 parts by mass of the binder resin. When the addition amount of the dye is 3 parts by mass or more with respect to 100 parts by mass of the binder resin, it is easy to exhibit the effect as the dye, and when the addition amount of the dye is 15 parts by mass or less with respect to 100 parts by mass of the binder resin, deterioration of the performance of the coating material due to deterioration of the dye over time is reduced.

Other additives can be added to the coating material within a range in which the reflection preventing performance thereof is maintained. Examples of the other additives can include a dispersant and an antifungal agent. An example of the dispersant can include a comb-type polymer dispersant such as SOLSPERSE 24000GR (manufactured by The Lubrizol Corporation).

In the coating material, the binder resin, the carbon black, the roughening particle, and the matting agent are dispersed in the solvent, and a general dispersion method can be used. For example, a ball mill, a paint shaker, a basket mill, a Dyno-mill, an Ultra visco mill, or an annular-type disperser can be used.

The surface reflection preventing coating film according to the present invention is a surface reflection preventing coating film formed by using the surface reflection preventing coating material. An average regular reflectance of the surface reflection preventing coating film at an incident angle of 20 degrees and an incident angle of 80 degrees in a visible light region (360 nm to 740 nm) is 0.5% or less. An average regular reflectance of the surface reflection preventing coating film at an incident angle of 20 degrees and an incident angle of 80 degrees in a near-infrared region (850 nm to 2,000 nm) is 3.0% or less. A diffuse reflectance of the surface reflection preventing coating film in the visible light region (360 nm to 740 nm) is 2.3% or less.

The coating film is formed by coating a substrate with the coating material according to the present invention and drying the substrate, but the formation method thereof is not particularly limited. Examples of a coating method can include spray coating, brush coating, roll coating, and dip coating. In addition, a drying method can be selected depending on application of hot air or far infrared light.

### EXAMPLES

Hereinafter, the present invention will be described in more detail with reference to examples and comparative examples, but the present invention is not limited by these examples.

Raw materials used in each of the examples and the comparative examples are as described below.

Acrylic resin: ACRYDIC A-166 (manufactured by DIC Corporation)
Carbon black: RAVEN 5000UII (manufactured by Columbia Chemical)
Hydrophobized dry silica: ACEMATT 3300 (manufactured by Evonik Japan Co., Ltd.)
Untreated dry silica: ACEMATT TS100 (manufactured by Evonik Japan Co., Ltd.)
Wet silica: ACEMATT OK412 (manufactured by Evonik Japan Co., Ltd.)
Polyamide-based resin particle (average particle diameter: 5 μm): SP-500 (manufactured by Toray Industries, Inc.)
Polyamide-based resin particle (average particle diameter: 10 μm): SP-10 (manufactured by Toray Industries, Inc.)
Polyamide-based resin particle (average particle diameter: 15 μm): TR-1 (manufactured by Toray Industries, Inc.)
Polyamide-based resin particle (average particle diameter: 20 μm): TR-2 (manufactured by Toray Industries, Inc.)
Polyamide-based resin particle (average particle diameter: 50 μm): Vestosint 2157 (manufactured by Daicel-Evonik Ltd.)
Polymethyl methacrylate (PMMA) resin particle (average particle diameter: 15 μm): Techpolymer MBX-15 (manufactured by SEKISUI PLASTICS CO., LTD.)
Polyurethane particle (average particle diameter: 15 μm): Art Pearl C-400 transparent (manufactured by Negami Chemical Industrial Co., Ltd.)
Dye: OIL BLACK HBB (manufactured by Orient Chemical Industries Co., Ltd.)
Organic solvent: butyl acetate (manufactured by Kishida Chemical Co., Ltd.)

### Example 1

22 parts by mass of carbon black, 14 parts by mass of hydrophobized dry silica, 34 parts by mass of a polyamide-based roughening particle having a particle diameter of 15 μm, and 133 parts by mass of an organic solvent were mixed with 100 parts by mass of an acrylic resin to prepare a coating material mixed liquid. The coating material mixed liquid was adjusted so that a total amount thereof became 200 g. Next, 20 balls with a diameter of 15 mm and 20 balls with a diameter of 10 mm (total: 112 g) were added and dispersed at 90 rpm for 5 hours by using a 500 ml ball mill, thereby preparing a coating material. The obtained coating material was coated onto a PET film with an applicator having a gap of 100 μm, dried at room temperature for 5 minutes, and further dried at 70 degrees for 20 minutes, thereby producing a coating film.

### Examples 2 to 10 and Comparative Examples 1 to 9

Coating materials were prepared in the same manner as that of Example 1, except that the types and amounts of the silica and the roughening particle used in the preparation of the coating material were changed as shown in Tables 1 and 2. In addition, coating films were produced by using the obtained coating material in the same manner as that of Example 1.

### Examples 11 to 13

In the preparation of the coating material mixed liquid in Example 1, 15 parts by mass of a dye in Example 11, 10 parts by mass of a dye in Example 12, and 3 parts by mass of a dye in Example 13 each were additionally mixed with 100 parts by mass of the acrylic resin. Coating materials were prepared in the same manner as that of Example 1 except for this. In addition, coating films were produced by using the obtained coating material in the same manner as that of Example 1.

(Measurement of Regular Reflectance)

For an evaluation of surface reflection preventing performance, a regular reflectance was measured. The regular reflectance of the obtained coating film formed on the PET film was measured with a spectrophotometer equipped with an absolute reflectance measurement unit (V-670, manufactured by JASCO Corporation). The regular reflectance (absolute reflectance) was measured under a measurement condition of a wavelength of 350 nm to 2,000 nm at intervals of 1 nm at an incident angle of 20 degrees and an incident angle of 80 degrees. An average value of measured values obtained in a wavelength of 360 nm to 740 nm was calculated as a regular reflectance in a visible light region. An average value of measured values obtained in a wavelength of 850 nm to 2,000 nm was calculated as a regular reflectance in a near-infrared region. The measurement results are shown in Tables 1 and 2.

(Measurement of Diffuse Reflectance)

For evaluations of blackness and pitch blackness of the surface of the coating film, a diffuse reflectance was measured. The diffuse reflectance of the obtained coating film formed on the PET film was measured with a spectrophotometer equipped with an integrating sphere unit having a diameter of 150 mm (V-670, manufactured by JASCO Corporation). Under a condition of a wavelength of 350 nm to 800 nm at intervals of 1 nm, the diffuse reflectance of only a diffuse reflection component was measured by removing the regular reflectance. An average value of measured values obtained in a wavelength of 360 nm to 740 nm was calculated as a diffuse reflectance. The measurement results are shown in Tables 1 and 2.

(Measurement of Liquid Viscosity)

In the measurement of a liquid viscosity, a B-type viscometer was used. The liquid viscosity was measured by a viscosity measuring apparatus (Vismetron VSA-1, manufactured by SHIBAURA SEMTEK CO., LTD.) under the following conditions. A liquid temperature was 25° C. Using No. 2 rotor, in a case of a viscosity range of 25 cPs to 2,500 cPs, a rotation speed was set to 12 rpm, and in a case of a viscosity range of more than 2,500 cPs, the rotation speed was set to 6 rpm.

(Measurement of Film Thickness)

A film thickness was measured by observing a cross section of the coating film with a scanning electron microscope (SEM). Specifically, the cross section of the coating film formed on the PET film was observed at a magnification of 1,000 times, the highest 5 points and the lowest 5 points of a height of the PET film in the observation range were measured and averaged, and an average value was defined as a film thickness. The measurement results are shown in Tables 1 and 2.

(Evaluation)

From the measurement results of the film thickness, the regular reflectance, and the diffuse reflectance, evaluations were conducted as follows.

A case where a condition in which the film thickness is 30 μm or less, a condition in which the regular reflectance at incident angles of 20 degrees and 80 degrees of visible light is 0.5% or less, a condition in which the regular reflectance at incident angles of 20 degrees and 80 degrees of near-infrared light is 3.0% or less, and a condition in which the diffuse reflectance of visible light is more than 2.2% and 2.3% or less are all satisfied was defined as B. A case where a condition in which the film thickness is 30 μm or less, a condition in which the regular reflectance at incident angles of 20 degrees and 80 degrees of visible light is 0.5% or less, a condition in which the regular reflectance at incident angles of 20 degrees and 80 degrees of near-infrared light is 3.0% or less, and a condition in which the diffuse reflectance of visible light is 2.2% or less are all satisfied was defined as A. A case where one of the conditions of B or A is not satisfied was defined as C.

From Example 1 and Comparative Examples 5 and 6, it can be appreciated that the polyamide-based resin particle is preferable as the roughening particle. In Comparative Example 5 in which the PMMA resin particle was used and Comparative Example 6 in which the polyurethane-based resin particle was used, the regular reflectance and the diffuse reflectance at 80 degrees of visible light and near-infrared light were inferior.

From Examples 1 to 3 and Comparative Examples 4 and 9, it can be appreciated that the particle diameter of the roughening particle is preferably 10 μm or more and 20 μm or less. In Comparative Example 4 in which the roughening particle having the particle diameter of 50 μm was used, the film thickness was increased to 60 μm, and the diffuse reflectance was inferior. In addition, in Comparative Example 9 in which the roughening particle having the particle diameter of 5 μm was used, the regular reflectance and the diffuse reflectance at 80 degrees of near-infrared light were inferior.

From Examples 1, 7, 8, and 9, it can be appreciated that the addition amount of the roughening particle is more preferably 29 parts by mass or more and 39 parts by mass or less with respect to 100 parts by mass of the binder resin. In a case where the addition amount of the roughening particle is 29 parts by mass or more and 39 parts by mass or less, the diffuse reflectance of visible light is 2.2% or less, and thus the pitch blackness is excellent. This case is evaluated as A.

From Example 1 and Comparative Examples 1 and 2, it can be appreciated that the hydrophobized dry silica is preferable. In Comparative Example 1 in which the untreated dry silica was used, the regular reflectance and the diffuse reflectance at 80 degrees of visible light and near-infrared light were inferior. In addition, in Comparative Example 2 in which the hydrophobized wet silica was used, the regular reflectance and the diffuse reflectance at 80 degrees of visible light and near-infrared light were also inferior.

From Examples 1, 4, 5, and 10 and Comparative Example 3, it can be appreciated that the addition amount of the hydrophobized dry silica is preferably 14 parts by mass or more, and more preferably 14 parts by mass or more and 19 parts by mass or less, with respect to 100 parts by mass of the binder resin. In Example 10 in which the addition amount of the hydrophobized dry silica was 22 parts by mass, the liquid viscosity was 3,000 cPs. Thus, the hydrophobized dry silica of Example 10 may be difficult to be coated.

From Examples 1 and 10 to 13, it can be appreciated that the reflection preventing performance of the obtained coating film is further excellent because the dye is contained in the coating material.

TABLE 1

| | Exam- | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|
| | ple | ple | ple | ple | ple | ple | ple | ple | ple | ple | ple | ple | ple |
| | 1 | 2 | 3 | 4 | 5 | 6 | 7 | 8 | 9 | 10 | 11 | 12 | 13 |
| Acrylic resin | 100 | 100 | 100 | 100 | 100 | 100 | 100 | 100 | 100 | 100 | 100 | 100 | 100 |
| Carbon black | 22 | 22 | 22 | 22 | 22 | 22 | 22 | 22 | 22 | 22 | 22 | 22 | 22 |
| Dry silica | 14 | 14 | 14 | 17 | 19 | 14 | 14 | 14 | 14 | 22 | 14 | 14 | 14 |
| (hydrophobized) | | | | | | | | | | | | | |
| Dry silica (untreated) | | | | | | | | | | | | | |
| Wet silica | | | | | | | | | | | | | |
| (hydrophobized) | | | | | | | | | | | | | |
| Roughening particle | | | | | | | | | | | | | |
| (5μ) PA | | | | | | | | | | | | | |
| Roughening particle | | 34 | | | | | | | | | | | |
| (10μ) PA | | | | | | | | | | | | | |
| Roughening particle | 34 | | | 34 | 34 | 24 | 29 | 39 | 44 | 34 | 34 | 34 | 34 |
| (15μ) PA | | | | | | | | | | | | | |
| Roughening particle | | | 34 | | | | | | | | | | |
| (20μ) PA | | | | | | | | | | | | | |
| Roughening particle | | | | | | | | | | | | | |
| (50μ) PA | | | | | | | | | | | | | |
| Roughening particle | | | | | | | | | | | | | |
| (15μ) PMMA | | | | | | | | | | | | | |
| Roughening particle | | | | | | | | | | | | | |
| (15μ) PU | | | | | | | | | | | | | |
| Organic solvent | 133 | 133 | 133 | 133 | 133 | 133 | 133 | 133 | 133 | 133 | 133 | 133 | 133 |
| Dye | | | | | | | | | | | 15 | 10 | 3 |
| Liquid viscosity (cPs) | 740 | 750 | 730 | 1000 | 1200 | 730 | 760 | 780 | 790 | 3000 | 800 | 770 | 750 |
| Film thickness (μm) | 25 | 21 | 24 | 28 | 25 | 22 | 21 | 23 | 25 | 26 | 23 | 22 | 19 |
| Regular reflectance (%) | 0.03 | 0.03 | 0.03 | 0.03 | 0.03 | 0.04 | 0.03 | 0.03 | 0.02 | 0.03 | 0.03 | 0.03 | 0.03 |
| (visible light) 20° | | | | | | | | | | | | | |
| Regular reflectance (%) | 1.22 | 1.22 | 1.26 | 1.13 | 1.14 | 1.23 | 1.18 | 1.22 | 1.24 | 1.10 | 1.20 | 1.19 | 1.19 |
| (near-infrared light) 20° | | | | | | | | | | | | | |
| Regular reflectance (%) | 0.38 | 0.38 | 0.39 | 0.34 | 0.33 | 0.40 | 0.39 | 0.38 | 0.37 | 0.29 | 0.34 | 0.36 | 0.36 |
| (visible light) 80° | | | | | | | | | | | | | |
| Regular reflectance (%) | 2.18 | 2.22 | 2.11 | 1.98 | 2.02 | 2.25 | 2.20 | 2.15 | 2.12 | 1.89 | 2.09 | 2.14 | 2.14 |
| (near-infrared light) 80° | | | | | | | | | | | | | |
| Diffuse reflectance (%) | 2.18 | 2.29 | 2.28 | 2.09 | 2.02 | 2.27 | 2.20 | 2.15 | 2.23 | 1.96 | 2.12 | 2.12 | 2.16 |
| Total evaluation | A | B | B | A | A | B | A | A | B | A | A | A | A |

TABLE 2

| | Compar- | Compar- | Compar- | Compar- | Compar- | Compar- | Compar- | Compar- | Compar- |
|---|---|---|---|---|---|---|---|---|---|
| | ative | ative | ative | ative | ative | ative | ative | ative | ative |
| | Exam- | Exam- | Exam- | Exam- | Exam- | Exam- | Exam- | Exam- | Exam- |
| | ple | ple | ple | ple | ple | ple | ple | ple | ple |
| | 1 | 2 | 3 | 4 | 5 | 6 | 7 | 8 | 9 |
| Acrylic resin | 100 | 100 | 100 | 100 | 100 | 100 | 100 | 100 | 100 |
| Carbon black | 22 | 22 | 22 | 22 | 22 | 22 | 22 | 22 | 22 |
| Dry silica (hydrophobized) | | | 11 | 14 | 14 | 14 | 14 | 14 | 14 |
| Dry silica (untreated) | 14 | | | | | | | | |
| Wet silica (hydrophobized) | | 14 | | | | | | | |
| Roughening particle (5μ) PA | | | | | | | | | 34 |
| Roughening particle (10μ) PA | | | | | | | | | |
| Roughening particle (15μ) PA | 34 | 34 | 34 | | | | 14 | 54 | |
| Roughening particle (20μ) PA | | | | | | | | | |
| Roughening particle (50μ) PA | | | | 34 | | | | | |
| Roughening particle (15μ) PMMA | | | | | 34 | | | | |
| Roughening particle (15μ) PU | | | | | | 34 | | | |
| Organic solvent | 133 | 133 | 133 | 133 | 133 | 133 | 133 | 133 | 133 |
| Dye | | | | | | | | | |
| Liquid viscosity (cPs) | 640 | 740 | 550 | 740 | 800 | 680 | 520 | 2000 | 660 |
| Film thickness (μm) | 28 | 26 | 21 | 60 | 25 | 25 | 22 | 26 | 28 |
| Regular reflectance (%) | 0.04 | 0.04 | 0.11 | 0.03 | 0.04 | 0.04 | 0.04 | 0.04 | 0.04 |
| (visible light) 20° | | | | | | | | | |
| Regular reflectance (%) | 1.56 | 1.74 | 1.95 | 1.14 | 1.29 | 1.32 | 1.23 | 1.21 | 1.78 |
| (near-infrared light) 20° | | | | | | | | | |
| Regular reflectance (%) | 0.71 | 0.69 | 0.88 | 0.39 | 0.59 | 0.64 | 0.48 | 0.46 | 0.78 |
| (visible light) 80° | | | | | | | | | |
| Regular reflectance (%) | 3.32 | 3.75 | 3.80 | 1.94 | 4.32 | 4.01 | 3.46 | 2.23 | 3.34 |
| (near-infrared light) 80° | | | | | | | | | |
| Diffuse reflectance (%) | 3.23 | 3.75 | 3.34 | 2.34 | 3.71 | 3.22 | 3.98 | 2.36 | 3.50 |
| Total evaluation | C | C | C | C | C | C | C | C | C |

According to the present invention, it is possible to provide a surface reflection preventing coating material and a surface reflection preventing coating film having high reflection preventing performance and excellent pitch blackness.

The present invention is not limited to the embodiments, and various alterations and modifications may be made without departing from the spirit and the scope of the present invention. Accordingly, in order to publicize the scope of the present invention, the following claims are attached.

What is claimed is:

1. A surface reflection preventing coating material comprising: a binder resin; carbon black; hydrophobized dry silica; a roughening particle; and a solvent,
wherein the roughening particle is a polyamide-based resin particle having an average particle diameter of 10 μm or more and 20 μm or less,
an addition amount of the polyamide-based resin particle is 24 parts by mass or more and 44 parts by mass or less with respect to 100 parts by mass of the binder resin, and
an addition amount of the hydrophobized dry silica is 14 parts by mass or more with respect to 100 parts by mass of the binder resin.

2. The surface reflection preventing coating material according to claim 1, wherein an addition amount of the hydrophobized dry silica is 14 parts by mass or more and 19 parts by mass or less with respect to 100 parts by mass of the binder resin.

3. The surface reflection preventing coating material according to claim 1, wherein an addition amount of the polyamide-based resin particle is 29 parts by mass or more and 39 parts by mass or less with respect to 100 parts by mass of the binder resin.

4. The surface reflection preventing coating material according to claim 1, further comprising a dye.

5. A surface reflection preventing coating film formed by using a surface reflection preventing coating material, the surface reflection preventing coating material containing: a binder resin; carbon black; hydrophobized dry silica; a roughening particle; and a solvent,
the roughening particle being a polyamide-based resin particle having an average particle diameter of 10 μm or more and 20 μm or less,
an addition amount of the polyamide-based resin particle being 24 parts by mass or more and 44 parts by mass or less with respect to 100 parts by mass of the binder resin, and
an addition amount of the hydrophobized dry silica being 14 parts by mass or more with respect to 100 parts by mass of the binder resin,
wherein an average regular reflectance at an incident angle of 20 degrees and an incident angle of 80 degrees in a visible light region (360 nm to 740 nm) is 0.5% or less, an average regular reflectance at an incident angle of 20 degrees and an incident angle of 80 degrees in a near-infrared region (850 nm to 2,000 nm) is 3.0% or less, and a diffuse reflectance in the visible light region (360 nm to 740 nm) is 2.3% or less.
